(19) United States
(12) Patent Application Publication
(10) Pub. No.: US 2015/0364880 A1
(43) Pub. Date: Dec. 17, 2015

(54) LOW-PROFILE COAXIAL CABLE SPLICE

(71) Applicant: 3M INNOVATIVE PROPERTIES COMPANY, Saint Paul, MN (US)

(72) Inventor: Kurt H. Petersen, Austin, TX (US)

(21) Appl. No.: 14/760,766

(22) PCT Filed: Feb. 6, 2014
(86) PCT No.: PCT/US2014/015062

§ 371 Date: Jul. 14, 2015

Related U.S. Application Data
(60) Provisional application No. 61/771,145, filed on Mar. 1, 2013.

(51) Int. Cl. H01R 24/40

(52) U.S. Cl. CPC H01R 24/40

(57) ABSTRACT

A low profile in-line splice for coaxial cables is described for making an electrical connection between the metallic contacts of the coaxial cable splice and to the inner and outer coaxial cable conductors is described herein. The exemplary low-profile coaxial cable splice device includes an inner conductive sleeve disposed concentrically within and spaced apart from an outer Cconductive sleeve and an outer housing disposed over the outer conductive sleeve. At least one of the inner conductive sleeve and the outer conductive sleeve includes a pair of hyperbolic contact regions separated by a bridging region.

### BACKGROUND OF THE INVENTION

1. Field of the Invention

The present invention is directed to a low profile coaxial cable splice. In particular, the splice includes at least one hyperbolic contact portion.

2. Background

Coaxial cables are used as transmission lines for radio frequency signals to interconnect electronic equipment, in applications such as connecting radio transmitters and receivers with their antennas, connecting computer networks (Internet), and distributing cable television signals.

Conventional coaxial cable, also known as coax cable, is usually a round electrical cable having an inner conductor disposed within a flexible, tubular dielectric layer, surrounded by an outer tubular conducting shield, and finally overcoated with a protective, insulating jacket. The term coaxial comes from the fact that the inner conductor and the outer shield share the same geometric axis.

Physical and aesthetic challenges exist in distributing coaxial cables in older buildings and structures. These challenges include gaining building access, limited distribution space in riser closets, and space for cable routing and management. In addition, physical and aesthetic challenges exist in providing coaxial cables within each individual living unit of a multi-dwelling unit (MDU) or within each office in an office building. Coaxial cables can be attached to walls below the ceiling in a living unit of an MDU, home, or other structure such as a multiple tenant unit (MTU), school, hotel, hospital or other location using staples, specialized connectors or an adhesive backed coaxial cable. The term “living unit” is not limited to a domicile or residence, but can include an office, conference room, hotel room, hospital room, class room or other similar room, whether or not it is continuously occupied. In some installations, it may be necessary to connect two or more lengths of coaxial cable to facilitate the desired cabling network within a living unit or to repair a damaged coaxial cable. In many cases, it may not be possible to locate this connection or splice point in a closet or cupboard resulting in the connection point being visible within the living unit. Thus, a low profile aesthetically pleasing coaxial cable splice is needed.

Conventional connectors for coaxial cables can be bulky and/or have angled contours that can reflect light at odd angles making them more visible to the casual observer. In addition, convention coaxial connectors can be cumbersome to install when working in very close proximity to the surface of a wall onto which the coaxial cable is attached. Conventional coaxial connectors are generally one of two designs. The first conventional coax connector design includes a male connector portion attached to the end each cable to be joined and a double ended female splicing sleeve which is positioned between the two male connection portions. The male connection portions are usually rotatably coupled to female splicing sleeve by either a threaded or bayonet connection. The second coax connector design includes a male connector portion attached to one of the coaxial cables and a female connection portion attached to the second of the coaxial cables. The male and female portions are usually rotatably coupled together to make the electrical connection.

### SUMMARY

According to an exemplary aspect of the present invention, an exemplary low profile in-line splice for coaxial cables and a novel method of making electrical contact between the metallic contacts of the coaxial cable splice and to the inner and outer coaxial cable conductors is described herein. The exemplary low-profile coaxial cable splice device includes an inner conductive sleeve disposed concentrically within and spaced apart from an outer conductive sleeve and an outer housing disposed over the outer conductive sleeve. At least one of the inner conductive sleeve and the outer conductive sleeve includes a pair of hyperbolic contact regions separated by a bridging region.

Advantageously, the exemplary low profile cable splice can be used to repair a damage coaxial cable or to join two segments of coaxial cable that are attached to a mounting surface such as a wall. In an exemplary aspect, the coaxial cable(s) can be adhesive-backed coaxial cable(s) that are adhesively bonded to the wall surface.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 shows a schematic view of an exemplary single family residence having a coaxial cable TV network with Data Over Cable Service Interface Specification (DOCSIS) data service;

FIG. 2 is an isometric view of adhesive backed coaxial cables that can be used in the cable network of FIG. 1;

FIG. 3 is an isometric view of an exemplary coaxial cable splice joining two adhesive backed coaxial cables in accordance with an aspect of the present invention;

FIG. 4 is a sectional view of the coaxial cable splice of FIG. 3;

FIG. 5A is an isometric view an outer conductive sleeve in accordance with an aspect of the present invention;

FIG. 5B shows a contact element used to form an outer conductive sleeve of the coaxial cable splice of FIG. 5A;

FIGS. 6A-6C are three views showing the disposition of an inner conductive sleeve relative to an outer conductive sleeve in accordance with an aspect of the present invention;

FIGS. 7A and 7B are two views showing alternative conductive sleeve constructions in accordance with aspects of the present invention; and

FIG. 8A and 8B are two views showing the splicing of two coaxial cables with an exemplary coaxial cable splice in accordance with an aspect of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Coaxial cables are capable of carrying bi-directional radio frequency (RF) signals and can be used to transmit large amounts of data. Cable television signals use only a portion of the bandwidth available over coaxial lines leaving plenty of bandwidth for other digital services such as Data Over Cable Service Interface Specification (DOCSIS), Multimedia over Coax Alliance (MoCA) home networking, cable telephony and wireless services.

As mentioned previously, coaxial cables are frequently used in living units and office buildings to route electrical and data signals. The present invention is a low profile coaxial splice or connector designed to interconnect two coaxial cables. In an exemplary aspect, the exemplary low profile coaxial cable splice can be used to interconnect two segments of adhesive-backed coaxial cable that are mounted to a wall or can be used to repair a wall mounted coaxial cable that has been damaged. The design of new coax cable splice will minimally affect the aesthetics of living unit of a multi-dwelling unit (MDU), home, or other premises structure such as a multiple tenant unit (MTU), school, hotel, hospital or other location where it is installed.

The exemplary low profile in-line splice for coaxial cables and a novel method of making electrical contact between the metallic contacts of the coaxial cable splice and to the inner and outer coaxial cable conductors is described herein. In one exemplary aspect, the exemplary coaxial cable splice can be used to electrically join two coaxial cables that are themselves mechanically anchored to a surface. As such, the splice can be smaller than other conventional coaxial cable connectors because it does not need to include features for rigidly retaining the coaxial cables. In an alternative aspect, the exemplary cable splice can include features to enhance the cable retention of the splice (e.g. integral crimp rings which can be crimped onto the exterior jacket of a coaxial cable or other conventional cable clamps).

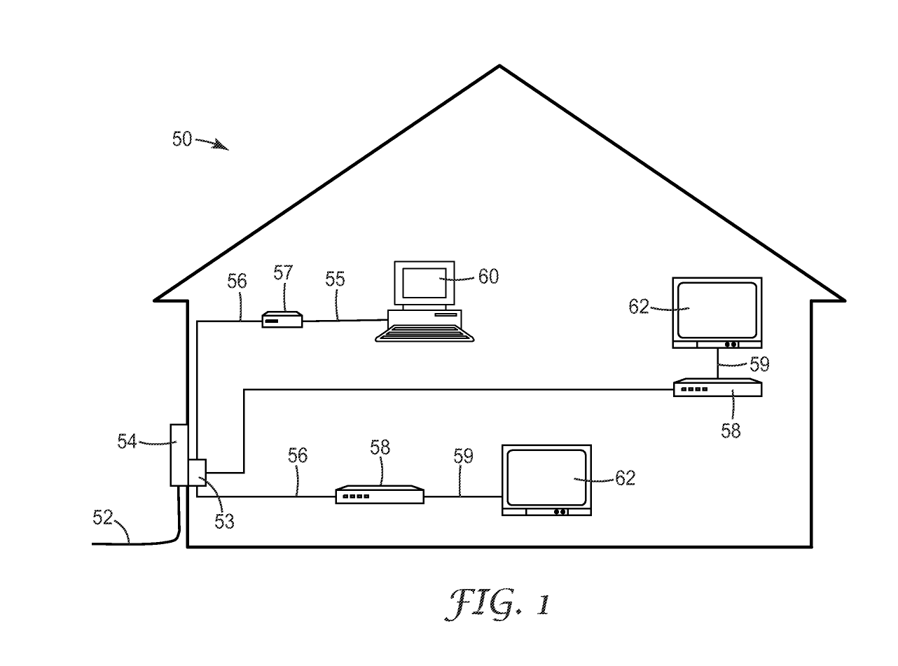

FIG. 1 shows an exemplary coaxial cable fed network within a single family residence or home 50. RF signals enter the home via coaxial feeder cable 52 through a coax network interface device 54. The incoming RF signal can be split into multiple local feeds by a coax splitter 53 and distributed by coaxial distribution cabling 56 throughout the residence to cable modems 57 for broadband internet service or to cable set-top boxes 58 for cable television service. Coaxial Jumper cables 59 can be used for the final connection from the cable set top box 58 to a television 62. Jumpers 55 from the cable modem 57 to computer 60 can be coaxial cable jumpers or Cat5e jumper cables.

Key attributes of a coaxial cable fed network as described above has the benefit of low cost and being an easy to install coaxial cabling solution. Coaxial cables can be used to transmit RF signals over a relatively long distance with low loss. Coaxial cables are typically used to distribute CATV signals within homes and MDU's, and to transmit cellular radio signals over passive distributed antenna systems (DAS).

This type of network is well suited for the exemplary low profile coaxial cable splices, described herein, to join or repair the coaxial distribution cables. The coaxial spice should have low insertion loss (<0.1 dB) and be well matched to the characteristic impedance of the coaxial cable (typically, 50 or 75 ohm) being joined by the splice. The installation procedure for the exemplary in line coaxial splice should utilize standard coaxial cable stripping tools and procedures to prepare the coaxial cables for termination in the splice.

When a cable TV system or coax based data distribution system is installed into an existing home, it may be inconvenient to hide the coaxial cables in walls or above the ceiling; instead the coaxial cables are typically routed along the floor or attached to the wall with conventional fasteners or staples, which can be unsightly. To overcome this problem, an adhesive backed coaxial cable solution, such as is described in U.S. Patent Publ. No. 2012-0292076 herein incorporated by reference in its entirety, can be used.

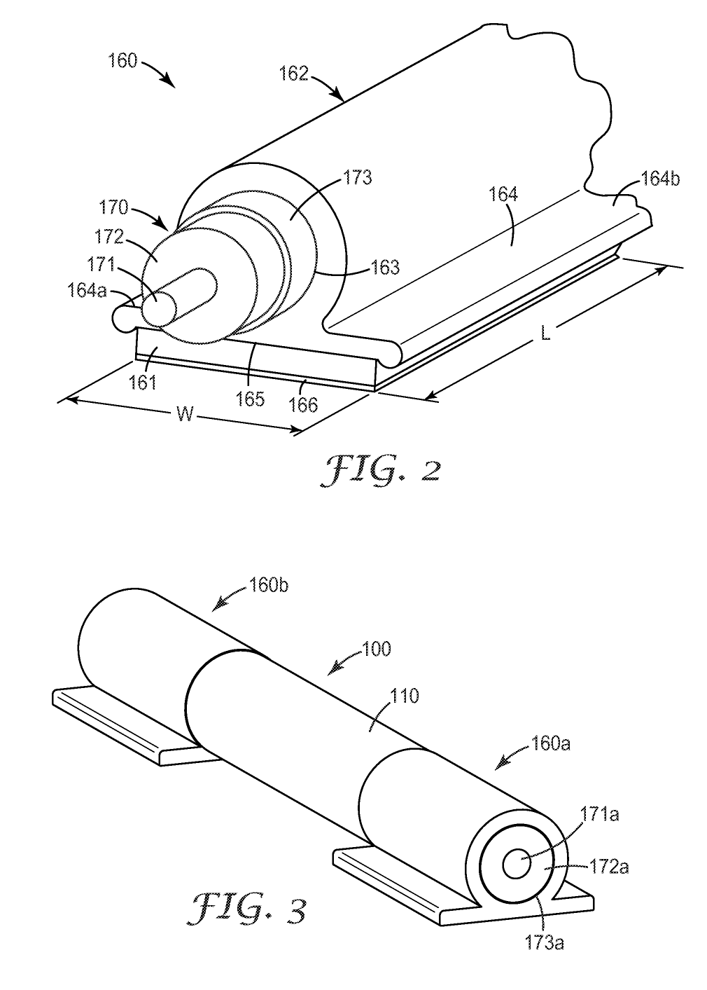

An exemplary adhesive-backed coaxial cable 160 is described with respect to FIG. 2. Adhesive-backed coaxial cable 160 is an elongated structure that may have a length (L) of up to several tens of meters (depending on the application) or even hundreds of meters that includes a conduit portion 162 having a bore 163 extending longitudinally therethrough to accommodate one or more coaxial lines disposed therein. For example coaxial core 170 can be accommodated in the bore of the conduit portion. The coaxial core comprises a central inner conductor 171 surrounded by a dielectric layer 172. The inner conductor can be a single conductive element or wire or a plurality of smaller gauge bare metal wires surrounded by the dielectric layer. Shielding layer 173 can be disposed over the dielectric layer 172. The shielding layer can help ground the adhesive-backed coaxial cable, help control the impedance of the cable as well as prevent electromagnetic interference or emissions from the cable. The shielding layer can be in the form of a metal foil or a braid or woven metal layer or a combination thereof which is disposed over the dielectric layer wrapped around the first inner conductor.

Adhesive-backed coaxial cable 160 also includes a flange 164 or similar flattened portion to provide support for the adhesive-backed coaxial cable 160 as it is installed on or mounted to a wall or other mounting surface, such as a floor, ceiling, or molding. Flange 164 extends along the longitudinal axis of the duct. Flange 164 includes a rear or bottom surface 165 that has a generally flat surface having an adhesive layer 161 disposed thereon for adhering the adhesive-backed coaxial cable 160 to a mounting surface, a wall or other surface (e.g., dry wall or other conventional building material) using an adhesive layer 161 with a removable liner 166. The adhesive layer can be in the form of a transfer adhesive or double-sided tape which is laminated to the bottom surface of the flange or can be an adhesive that is directly applied to the bottom surface of the flange at the time of installation.

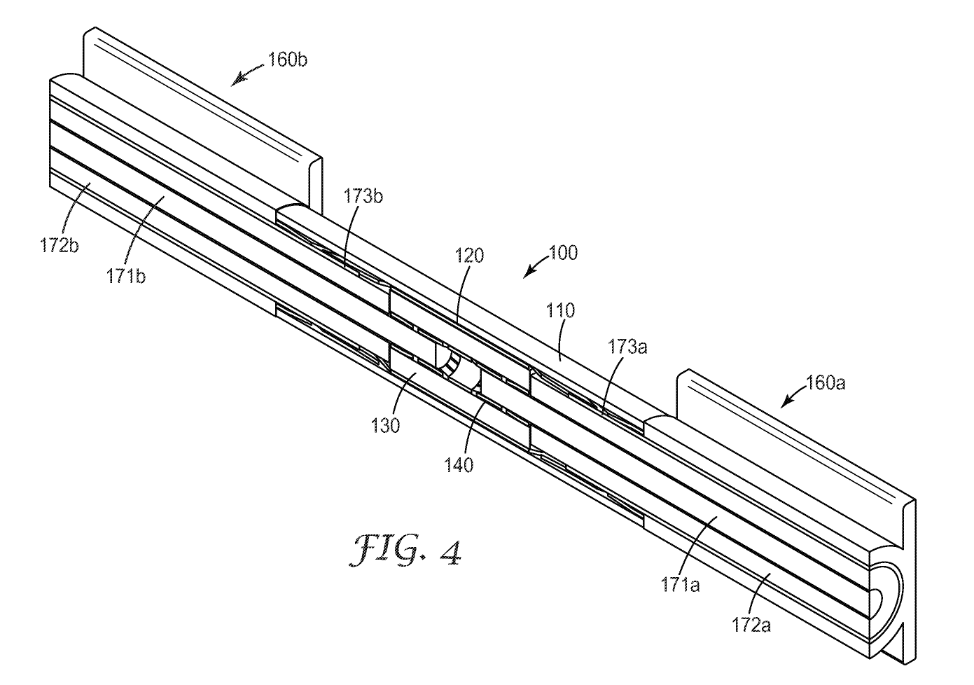

As previously mentioned, it may be necessary to connect two coaxial cables to extend the length of a coaxial cable segment or repair a damaged coax cable which had been previously installed on the wall within a building, or a splice may be used to connect coaxial cable to a piece of equipment with a pre-stubbed tail. FIGS. 3 and 4 show an exemplary low profile coaxial cable splice 100 disposed between a first adhesive-backed coaxial cable 160a and a second adhesive-backed coaxial cable 160b. Coaxial cable splice 100 includes an inner conductive sleeve 140 disposed concentrically within and spaced apart from an outer conductive sleeve 120 and an outer housing 110 disposed over the outer conductive sleeve. In an exemplary aspect, a dielectric layer 130 can be disposed between the inner conductive sleeve and the outer conductive sleeve to electrically insulate the two conductive sleeves from one another and to match the cable impedance of the coaxial cables being connected by the exemplary cable splice 100. The outer housing can have a substantially tubular shape and can be formed from an insulating dielectric material such as polyvinyl chloride (PVC) or a low smoke zero halogen polyolefin.

In an exemplary aspect, dielectric layer 130 will have a bulk dielectric property of less than about 3.0 and can be formed from a closed or open cell polyethylene foam, or a solid tube of polyethylene or polytetrafluoroethylene (PTFE).

The inner and outer conductive sleeves 140, 120 can also have a generally tubular shape. The inner conductive sleeve 120 is configured to electrically connect the inner conductors 171a, 171b of adhesive-backed coaxial cables 160a, 160b. The outer conductive sleeve 140 is configured to electrically connect the shielding layers 173a, 173b of adhesive-backed coaxial cables 160a, 160b.

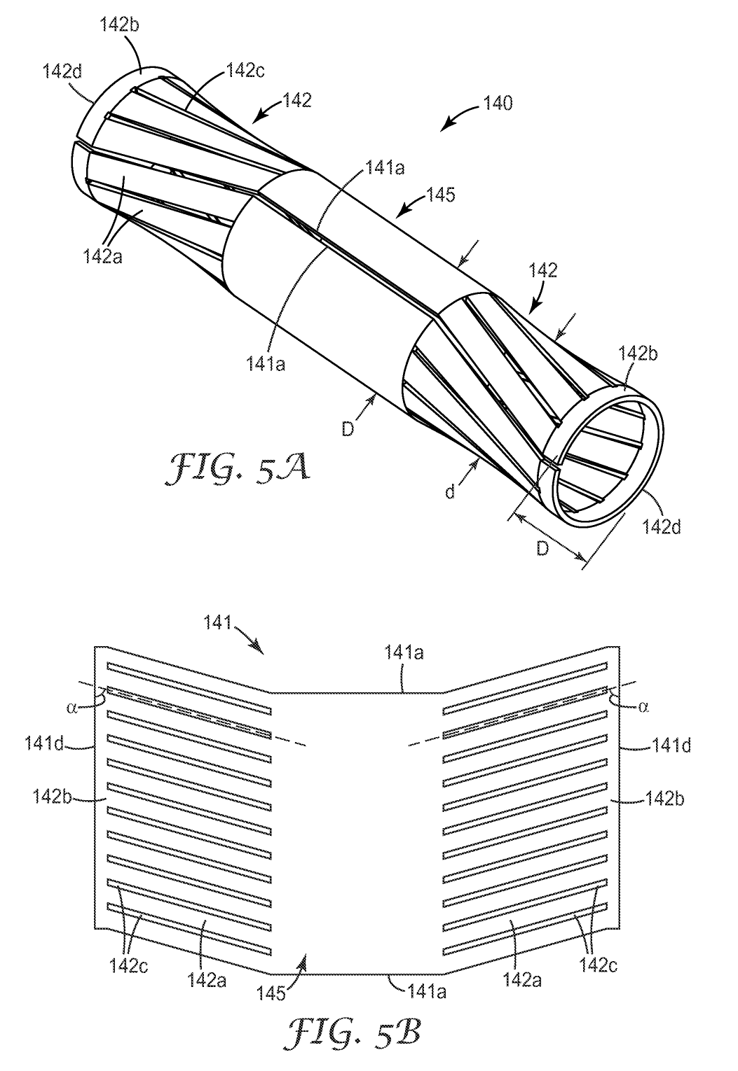

In an exemplary aspect, at least one of the inner conductive sleeve 120 and the outer conductive sleeve 140 can include a pair of hyperbolic contact regions separated by a bridging region. FIG. 5A shows a schematic drawing of a portion of a conductive sleeve, for example outer conductive sleeve 140. Outer conductive sleeve 140 includes a pair of hyperbolic contact regions 142 separated by a bridging region 145. Hyperbolic contact region 142 is a hyperboloid sleeve formed by a series of adjacent parallel slats 142a connected to bridging region 145 at a first terminal end of the slats and an outer stabilizing band 142b at a second terminal end of the slats. At least one of the conductive sleeves can be formed from a substantially flat contact element. For example, contact element 141 of outer conductive sleeve 140 is shown in FIG. 5B. In an exemplary aspect, contact element 141 can be a first substantially flat chevron shaped piece of conductive material having two straight transverse edges 141d and two longitudinal edges 141a. Contact element 141 can include a plurality of substantially parallel inclined slots 142c extending between the bridging region 145 and outer stabilizing band 142b of unbroken material adjacent to the transverse edges of the contact element. Slots 142c define the slats 142a connecting the bridging region 145 and the outer stabilizing band 142b. In a preferred aspect, slots 142c are inclined at an angle, α, with respect to the transverse edge of the conductive element 141. In an aspect of the invention, the angle α can be between about 63° and about 73°, while in a preferred aspect the angle α can be between about 66° and about 70°.

The contact element 141 can be rolled around a mandrel until the longitudinal edges 141a are disposed adjacent and approximately parallel to one another to form the outer conductive sleeve 140 as shown in FIG. 5A. The slats 142a form the hyperbolic contact regions 142 on either side of bridging region 145 when the contact element is formed into the outer conductive sleeve. The slot width and number of slots can be selected to maintain the shielding effectiveness of the outer conductive sleeve while allowing sufficient resiliency in the slats 142a to provide a reliable electrical connection to the shield layer of coaxial cable being spliced.

The slot pattern (i.e. the angle and number of slots) of the contact element 141 is designed to provide a resilient inward radial force by slats 142a on the shielding layers of the coaxial cables disposed in the hyperbolic region of the outer conductive sleeve. This is accomplished by the smaller minimum diameter, d, of the hyperbolic contact regions 142 compared to the diameter, D, of the bridging region 145 and outer stabilizing ring 142b of the outer conductive sleeve. The angle of the slots affects the ratio in the diameter of the hyperbolic region compared to the diameter of the bridging region and outer stabilizing ring. As the angle α becomes smaller, the ratio d/D becomes smaller. In an exemplary aspect, the minimum diameter, d, of the hyperbolic region of the outer conductive sleeve is less than the outer diameter of the shielding layers of the coaxial cables to be spliced while the diameter, D, of the outer stabilizing ring is slightly larger than the outer diameter of the shielding layers to provide clearance for insertion of the cable into the outer conductive sleeve 140.

The slats 142a of the hyperbolic regions can be deflected outward as the coaxial cables are inserted into the exemplary splice 100. The slats, in turn, provide an inward contact force against the shielding layers of the coaxial cables. In addition to providing the necessary contact force to mate the shielding layers to the coaxial cable cable, the outer conductive sleeve provides multiple points of electrical contact (i.e. at each slat around the conductive sleeve) to the shielding layers of the coaxial cable. Providing adequate contact force and multiple contact sites around the conductors is necessary for high power signal transmission and to reduce passive inter-modulation distortion.

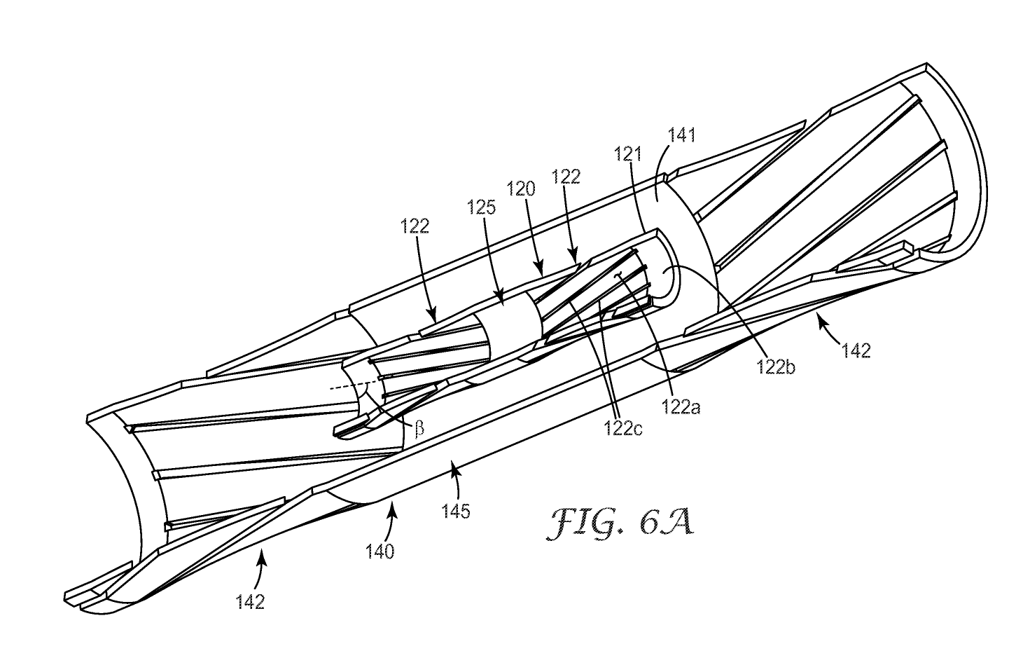

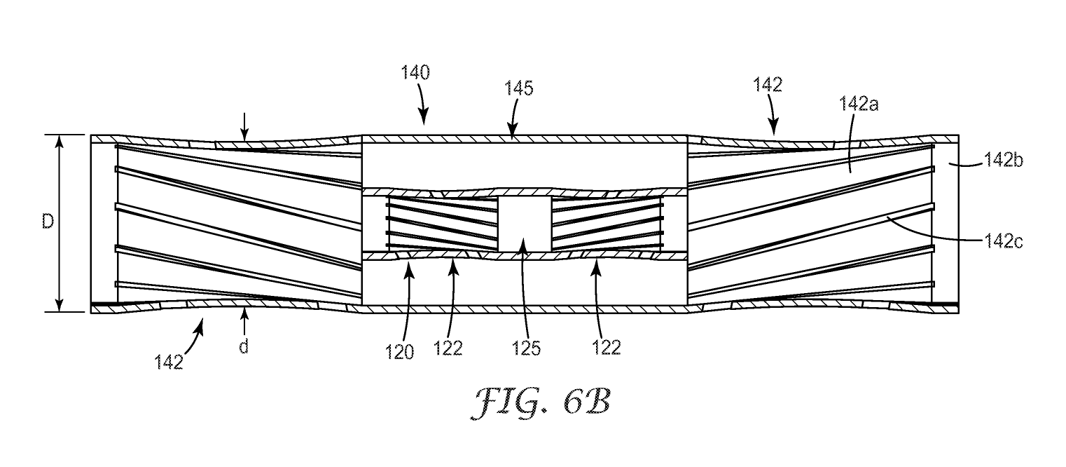

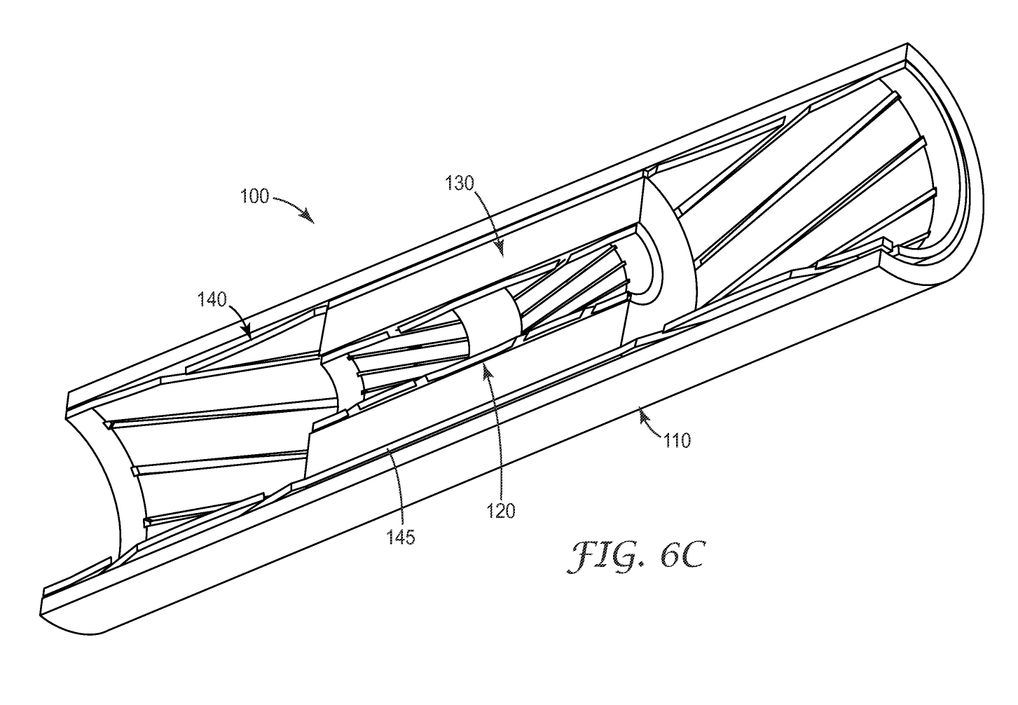

Similarly, the inner conductive sleeve 120 can have a structure similar to outer conductive sleeve 140 as shown in FIGS. 6A-6C. Inner conductive sleeve 120 can also be formed from a substantially flat conductive element 121 that has been rolled around a mandrel or formed in a die to form a tubular sleeve contact element. Conductive element 121 can be a first substantially flat chevron shaped piece of metal having a plurality of substantially parallel inclined slots 122c defining slats 122a disposed on either side of bridging region 125. The slotted portions of the contact element 121 form the hyperbolic contact regions 122 on either side of the bridging region of the inner conductive sleeve after it has been rolled into its preferred tubular form.

Hyperbolic contact regions 122 of the inner conductive sleeve 120 can be a hyperboloid sleeve formed by the adjacent parallel slats 122a connected to bridging region 125 at a first terminal end of the slats and an outer stabilizing band 122b at a second terminal end of the slats.

In a preferred aspect, slots 122c are inclined at an angle, β (shown in FIG. 6A), with respect to the transverse edge of the conductive element 121 of the inner conductive sleeve 120. In an aspect of the invention, the angle β can be between about 53° and about 63°, while in a preferred aspect the angle β can be between about 56° and about 60°. The slot pattern (i.e. the angle and number of slots) of contact element 121 can be designed to provide a resilient inward radial force by slats 122a, thus ensuring a reliable electrical connection between the inner conductors of the coaxial cablea being spliced and the inner conductive sleeve 120.

As described previously, the hyperbolic contact regions 122 can have a smaller minimum diameter than the diameter of the bridging region 125 and outer stabilizing ring 122b of the inner conductive sleeve 120. In an exemplary aspect, the minimum diameter of the hyperbolic region of the inner conductive sleeve is less than the outer diameter of the inner conductors of the coaxial cables to be spliced while the diameter of the outer stabilizing ring is slightly larger than the outer diameter of the inner conductor to provide clearance for insertion of the inner conductors of the coaxial cables into the inner conductive sleeve 120.

The slats 122a of the hyperbolic regions of the inner conductive sleeve can be deflected outward as the inner conductor of the coaxial cables are inserted into the exemplary splice. The slats, in turn, provide an inward contact force against the inner conductors of the coaxial cables. This allows easy passage of the inner conductors of the coaxial cable past outer stabilizing ring 122b while ensuring that the slats 122a of inner conductive sleeve exert a sufficient inward radial force to ensure a reliable electrical connection. In addition to providing the necessary contact force to electrically connect the inner conductors of the coaxial cables, the inner conductive sleeve provides multiple points of contact (i.e. at each slat around the conductive sleeve) to enable high power signal transmission and to reduce passive inter-modulation distortion.

Conductive element 121 of the inner conductive sleeve 120 can be rolled around a mandrel until the longitudinal edges are disposed adjacent and approximately parallel as described previously with respect to conductive element 141 of the outer conductive sleeve 140.

In an exemplary aspect, the conductive material of the conductive elements 121, 141 for the inner and outer conductive sleeves 120, 140 can be formed from a high strength, non-magnetic metal or metal alloy having a high electrical conductivity, such as a beryllium copper alloy (ASTM Alloy 172). The conductive elements can also have a plated metallic surface such as hard gold plated surface to improve wear resistance or white bronze (an alloy of copper, tin and zinc) to improve RF inter-modulation performance. The slots 122c, 142c can be formed in contact elements 121, 141 via stamping, milling, laser cutting or etching a slot pattern created by a photolithographic process. To maintain a high shielding effectiveness of the coaxial cable splice 100, the slot pattern on the outer conductive sleeve 140 can be designed such that a minimum amount of the conductive material (e.g.

metal) is removed when the slots are formed.

FIGS. 6A-6C show the relative positioning of the elements of the exemplary low profile coaxial cable splice of the current disclosure. In FIG. 6C, the inner conductive sleeve 120 can be disposed within dielectric layer 130. The dielectric layer enclosing the inner conductive sleeve is disposed within the bridging region 145 of the outer conductive sleeve 140. The outer housing 110 surrounds the outer conductive sleeve 140.

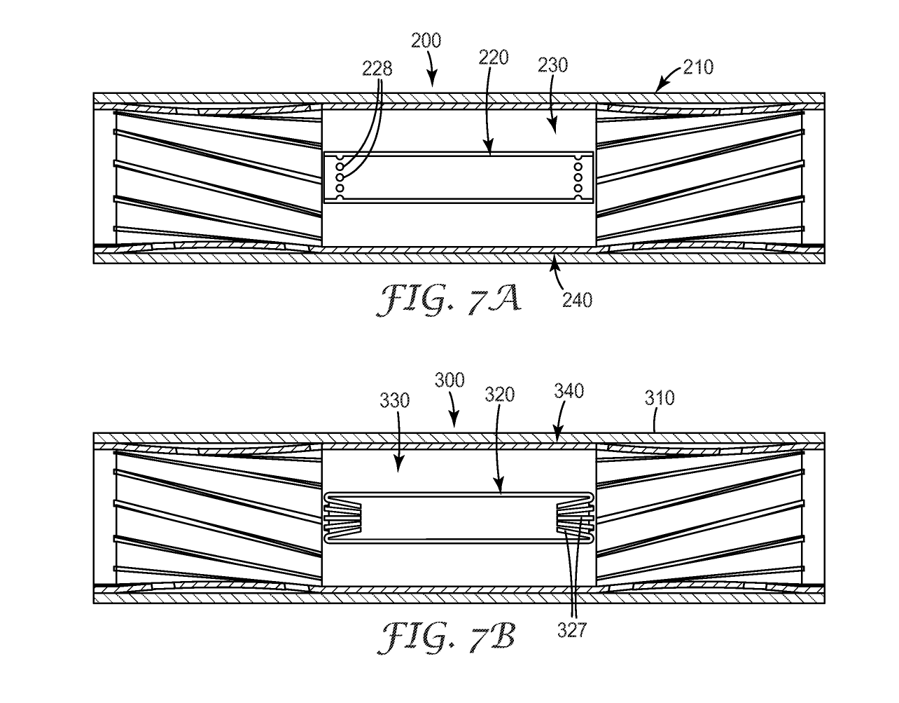

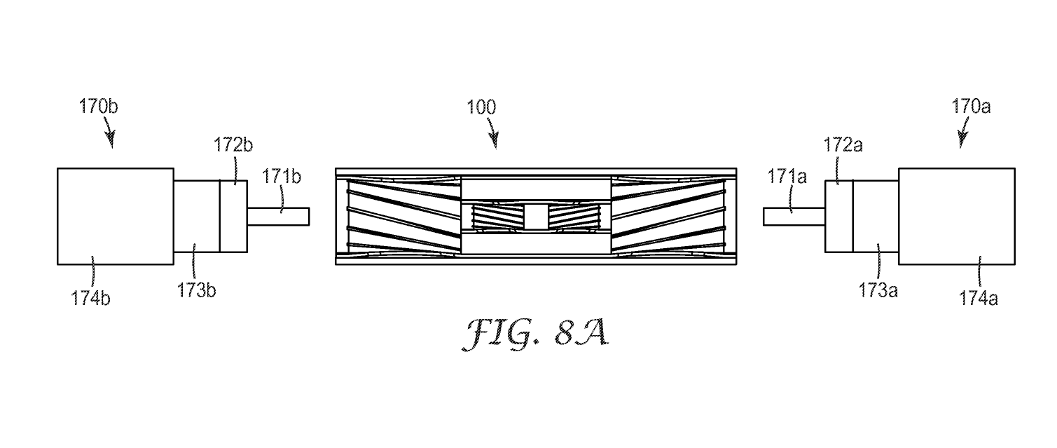

FIGS. 7A and 7B show two alternative conductive sleeve constructions in accordance with an aspect of the present invention. FIG. 7A shows a cross-section of coaxial splice 200. Coaxial splice 200 includes an inner conductive sleeve 220 disposed concentrically within and spaced apart from an outer conductive sleeve 240 and an outer housing 210 disposed over the outer conductive sleeve. In this exemplary aspect, a dielectric layer 230 can be disposed between the inner conductive sleeve 220 and the outer conductive sleeve 240 to insulate the two conductive sleeves from one another. In one exemplary aspect, the outer conductive sleeve 240, outer housing 210 and dielectric layer 230 of coaxial splice 200 can be analogous the outer conductive sleeve 140, outer housing 110 and dielectric layer 130 of coaxial splice 100, respectively.

In the exemplary coaxial cable splice 200, the inner conductive sleeve has been modified. The inner conductive sleeve 220 includes a substantially solid tubular body having an array of protrusions 228 extending from the interior surface of the inner conductive sleeve. The distance between the top surfaces of opposing protrusions should be slightly less than the diameter of the inner conductor of the coaxial cables to be spliced to ensure a reliable electrical connection between the inner conductive sleeve and the inner conductors of the coaxial cables to be spliced by exemplary coaxial cable splice 200. Inner conductive sleeve 200 is shown as having a one dimensional array of protrusions disposed around the inner circumference of the inner conductive sleeve. In another exemplary array, the array of protrusions can be a two dimensional array having an aligned, staggered or random arrangement of protrusions extending from the interior surface of the inner conductive sleeve.

In an alternative aspect, an exemplary coaxial cable splice can have a hyperbolic inner sleeve similar to inner conductive sleeve 120 and a solid tubular outer conductive sleeve that includes an array of protrusions extending from the inner surface of the sleeve between each terminal end of the outer conductive sleeve and the bridging region which supports the dielectric layer and the inner conductive sleeve. The distance between the tops of opposing protrusions should be slightly less than the diameter of the outer conductor of the coaxial cables to be spliced to ensure a reliable electrical connection between the outer conductive sleeve and the outer conductors of the coaxial cables to be spliced.

FIG. 7B shows a cross-section of coaxial splice 300. Coaxial splice 300 includes an inner conductive sleeve 320 disposed concentrically within and spaced apart from an outer conductive sleeve 340 and an outer housing 310 disposed over the outer conductive sleeve. In an exemplary aspect, a dielectric layer 330 can be disposed between the inner conductive sleeve and the outer conductive sleeve to insulate the two conductive sleeves from one another. In one exemplary aspect, the outer conductive sleeve 340, outer housing 310 and dielectric layer 330 of coaxial splice 300 can be analogous the outer conductive sleeve 140, outer housing 110 and dielectric layer 130 of coaxial splice 100, respectively.

In the exemplary coaxial cable splice 300, the inner conductive sleeve has been modified. Inner conductive sleeve 320 includes a substantially solid tubular body having an array of resilient fingers 327 extending into the passageway through the inner conductive sleeve. The distance between the ends of the opposing resilient fingers (i.e. fingers that are oriented 180° from one another) is less than the diameter of the inner conductor of the coaxial cables to be spliced to ensure a reliable electrical connection between the inner conductive sleeve and the inner conductors of the coaxial cables to be spliced by exemplary coaxial cable splice 300. Thus, when the inner conductor of a coaxial cable is pushed into inner conductive sleeve 320, the inner conductor causes the resilient fingers to flex toward the interior surface of the inner conductive sleeve. The resilient fingers exert an inward radial force on the inner conductor to ensure reliable electrical contact.

In an alternative aspect, an exemplary coaxial cable splice can have a hyperbolic inner sleeve similar to inner conductive sleeve 120 and an outer conductive sleeve having resilient fingers extending from each terminal end of the conductive sleeve into the interior passage through the outer conductive sleeve between each terminal end of the outer conductive sleeve and the bridging region which supports the dielectric layer and the inner conductive sleeve.

The low profile coaxial cable splice of the current invention can be designed to match the impedance requirements of the coaxial cables that it joins. For example, a 3D finite difference time domain (FDTD) model using CST Microwave Studio Software from Computer Simulation Technology, Inc. (Framingham, Mass.) can be used to design an exemplary 50 ohm coaxial cable splice that joins two LMR-240 coaxial cables (made by Times Microwave of Wallingford, Conn.). The splice was designed to accept a 1.4 mm diameter center conductor of the cable, and a 4.5 mm diameter outer conductor. To match the impedance of the LMR-240 cable, a material with a dielectric constant of 1.4 was used to form the insulating region of the splice body (i.e. the dielectric layer between the inner and outer conductive sleeves). RF models for this exemplary cable splice show a return loss of less than −20 dB and an insertion loss of less than −0.1 dB.

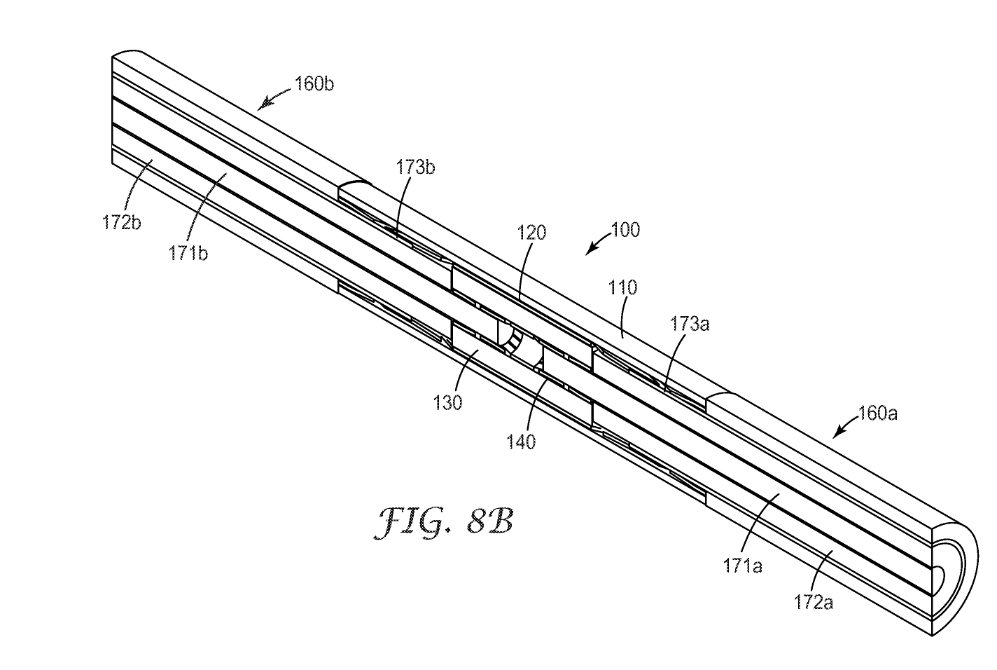

To install coaxial splice 100, the terminal ends of the coaxial cables 170a, 170b to be joined can be prepared using a conventional stripping tool. The coax cables are stripped to reveal the central inner conductors 171a, 171b and the shielding layers 173a, 173 as shown in FIG. 8A. The lengths of the stripped sections are matched to the requirements of the coaxial splice's dimensions. The stripped coaxial cables are then inserted into each side of the splice. The inner conductive sleeve 120 makes contact between the central inner conductors of the coaxial cables, while the outer conductive sleeve makes contact between the shielding layers of the coaxial cables. When the dielectric material 172a, 172b of the coaxial cable touches the dielectric layer 130 inside the splice, the coaxial cable has been fully inserted into the splice as shown in FIG. 8B.

When used with an adhesive based ducted coaxial cables, the exemplary low profile coaxial cable splice provides an aesthetic and reliable electrical connection between the coaxial cables. Because the cables are adhesively secured to a surface within a residence or MDU, bulky cable retention features can be eliminated from the exemplary coaxial cable splice providing an unobtrusive cable connection. In contrast conventional coaxial cable splices require that RF connectors be attached to the ends of the coaxial cables first. Then, the RF connectors are then screwed on to the conventional coaxial splice. The present invention eliminates the need for these RF connectors on the coaxial cables and allows for the direct connection of coaxial cables. The hyperbolic structure of the splice metal contact provides a spring loaded force to promote electrical contact between the splice and the cable conductors. In addition the low profile design of the exemplary splice described herein allows for the cables to be placed closer together than conventional coaxial cable connectors and splices (i.e. there is less space between adjacent parallel lengths of sliced coaxial cables).

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. A low-profile coaxial cable splice device, comprising:
an inner conductive sleeve disposed concentrically within and spaced apart from an outer conductive sleeve and an outer housing disposed over the outer conductive sleeve,
wherein at least one of the inner conductive sleeve and the outer conductive sleeve comprises a pair of hyperbolic contact regions separated by a bridging region.

2. The splice device of claim 1, further comprising a dielectric insulating layer disposed between the inner and outer conductive sleeves.

3. The splice device of claim 1, wherein the inner conductive sleeve comprises a first pair of hyperbolic contact regions separated by a first bridging region and the outer conductive sleeve comprises a second pair of hyperbolic contact regions separated by a second bridging region.

4. The splice device of claim 1, wherein the inner conductive sleeve comprises a first substantially flat chevron shaped piece of metal having a plurality of inclined slots disposed within each of the hyperbolic contact regions on either side of a first bridging region and wherein the first chevron shaped piece of metal has been rolled around a mandrel to form the inner conductive sleeve.

5. The splice device of claim 4, wherein the inner conductive sleeve has a generally tubular shape.

6. The splice device of claim 4, wherein the first bridging region of the inner conductive sleeve has a larger diameter than a minimum diameter of each of the first hyperbolic contact regions disposed of either side of the first bridging region.

7. The splice device of claim 1, wherein the outer conductive sleeve comprises a second substantially flat chevron shaped piece of metal having a plurality of inclined slots disposed within each of the hyperbolic contact regions on either side of a second bridging region and wherein the second chevron shaped piece of metal has been rolled around a mandrel to form the outer conductive sleeve.

8. The splice device of claim 7, wherein the outer conductive sleeve has a generally tubular shape.

9. The splice device of claim 7, wherein the second bridging region of the outer conductive sleeve has a larger diameter than a minimum diameter of each of the second hyperbolic contact regions disposed of either side of the second bridging region.
